(19) United States
(12) Patent Application Publication
(10) Pub. No.: US 2011/0014388 A1
(43) Pub. Date: Jan. 20, 2011

(54) AMBIENT CURE PAINTING METHOD WITH WATERBORNE BASECOAT

(75) Inventors: Gregory A. Brainard, Spencer, OH (US); David A. McCord, Medina, OH (US); Thomas J. Staunton, Euclid, OH (US)

Correspondence Address: THE SHERWIN-WILLIAMS COMPANY, 101 PROSPECT AVENUE N.W., 1100 MIDLAND BLDG. - LEGAL DEPARTMENT, CLEVELAND, OH, 44115-1075, US

(73) Assignee: THE SHERWIN-WILLIAMS COMPANY, Cleveland, OH (US)

(21) Appl. No.: 12/836,055

(22) Filed: Jul. 14, 2010

Related U.S. Application Data
(60) Provisional application No. 61/225,345, filed on Jul. 14, 2009.

(51) Int. Cl. C08F 2/48; C08J 7/18

(52) U.S. Cl. 427/514; 427/521

(57) ABSTRACT

Methods and associated compositions are described for applying onto a substrate a cured coating that includes at least one layer of a water-borne basecoat and one layer of clearcoat and that requires a maximum total curing time of less than about 45 minutes. Further described are methods and associated compositions for applying onto a substrate a cured coating that includes at least one layer of primer, at least one layer of a water-borne basecoat and at least one layer of clearcoat and that requires a maximum total curing time of less than about 65 minutes.

This application claims priority from co-pending U.S. Provisional Application No. 61/225,345 filed Jul. 14, 2009, the entirety of which is hereby incorporated by reference.

The present invention relates to methods and compositions for repairing damage to painted surfaces, particularly vehicle surfaces like trunk panels, door panels, hoods, roof panels, side panels, and the like, though, some embodiments of the invention may be useful processes for painting a substrate. More specifically, the present invention describes a rapid, refinish painting process or spot repair process comprising the application of at least one layer of a water -borne basecoat composition and at least one layer of a clearcoat composition. The methods described provide a total overall cure time for all applied layers of less than about 45 minutes in a process that does not include applying a primer coat layer, but includes applying at least one layer of a basecoat and at least one layer of a clearcoat; and less than about 65 minutes in a process that involves applying at least one layer of each of a primer coat, basecoat, and clearcoat.

Motor vehicle panels, such as bumpers, doors, quarter panels, hoods, and the like are usually metal or plastic substrates coated by a coating system that comprises at least a basecoat, which is often tinted, and a clearcoat, to protect the basecoat from environmental hazards. In some cases, a primer coat is applied to the substrate before the basecoat to provide enhanced protection of the substrate against environmental conditions and/or to improve adhesion of the basecoat to the substrate.

From time to time, the coating on a vehicle panel can become scratched or otherwise damaged, thereby necessitating a repair either for purely aesthetic reasons, or to preserve the integrity of the panel from further damage, such as from rust.

A variety of methods and products have been developed for “spot” repairing damaged coatings, such as the damage caused by surface impacts. However, existing methods for making these types of repairs, particularly spot repairs of damage that extends through the clearcoat and into the basecoat and/or primer coat, are very time consuming to perform effectively, generally owing to the extensive cure times between layers. The large amount of time required to effectively repair scratches in vehicle panels using existing repair methods and products is a significant detriment to undertaking the repair. The more time required to perform the repair, the less number of repairs can be performed, and the greater amount of time that a vehicle owner will be without access to their vehicle. These raise the cost of each repair, making it less likely or desirable that a vehicle owner would make elective paint repairs, such as to relatively minor scratch and dent spot repairs. However, failure to timely make even spot repairs can leave the vehicle susceptible to further damage.

Many existing approaches for rapidly repairing multi-layer coating make sole use of solvent-borne primer, basecoat and topcoat compositions. Substituting water-borne coating compositions is a technical challenge in rapid repair systems because of the relatively slower cure times of water-borne coatings. However, water-borne coatings have many benefits, particularly environmental benefits over solve-borne counterparts—thus making water-borne coating compositions particularly desirable to use.

In light of the benefits associated with using water-borne coatings, it remains desirable, to develop a system for spot repairing a painted substrate, or otherwise spot painting a substrate, wherein the repair constitutes at least application of one or more layers of a water-borne basecoat compositions and at least one or more layers of clearcoat composition, which can be cured (dry to sand and buff), in less than about 1 hour of total curing time (i.e., time dedicated to allowing the layers to cure through to the point at which the final clearcoat layer can be buffed). It would further be useful if the repaired coating area substantially equaled the color and physical performance of the surrounding, undamaged coating areas, so that the appearance of the repaired area is substantially indistinguishable from the surrounding undamaged coating.

### DETAILED DESCRIPTION OF THE INVENTION

The present invention describes a method for and basecoat and clearcoat compositions, which are useful for imparting onto a substrate a cured coating comprising at least one layer of a water-borne basecoat and one layer of clearcoat, that requires a maximum total curing time of less than about 45 minutes.

In another embodiment, the present invention describes a method for and primer, basecoat, and clearcoat compositions, which are useful for imparting onto a substrate a cured coating comprising at least one layer of primer, at least one layer of a water-borne basecoat and at least one layer of clearcoat, that requires a maximum total curing time of less than about 65 minutes.

In one embodiment of the invention, the method may comprise the steps of:

(a) applying radiant heat to a substrate;

(b) applying at least a first layer of a water-borne basecoat composition to the substrate;

(c) force flashing the basecoat composition with ambient temperature air; and

(d) applying at least a first layer of an ambient cure clearcoat composition to the layer of basecoat composition.

In another embodiment, following the step of force flashing the basecoat composition with ambient temperature air, the method may include the steps of:

(i) applying radiant heat to the substrate;

(ii) applying a second layer of a water-borne basecoat composition on top of the first layer of the basecoat composition; and

(iii) force flashing the second basecoat layer with a flow of ambient temperature air.

According to another embodiment, a method of making repairs to a substrate, may include the steps of

(a) applying at least a first layer of an ambient cure primer composition to a substrate, wherein the primer composition sufficiently cures at ambient temperatures to allow sanding of the primer layer within 20 minutes after application;

(b) applying radiant heat to the substrate;

(c) applying at least a first layer of a water-borne basecoat composition to the primer layer;

(d) force flashing the basecoat composition with a flow of ambient temperature air for between about 1 to about 5 minutes; and

(e) applying at least a first layer of an ambient cure clearcoat composition to the layer of basecoat composition

For purposes of clarity, it will be understood that the methods described herein relate to the application of at least a water-borne basecoat layer and a clearcoat layer to a substrate. In some embodiments, the additional application of a primer coat layer is also disclosed. The contexts in which such methods may be usefully practiced may include, but are not limited to, the aftermarket repair of a portion of a previously painted substrate that has been damaged, so as, for example, to correct the appearance of the damaged portion; however, as will be understood, the methods may be used on a new substrate that has not been previously painted.

The method comprises the step of providing a suitable panel (synonymous with substrate) having a damaged or unfinished portion to paint. For purposes herein, the portion of the panel to receive the coating compositions according to the methods described herein will be referred to as the “repair area”. The panel may be any material or combination of materials that is conventionally finished with a basecoat/clearcoat finishing system. In a one embodiment, the panel is a vehicle panel, such as a door panel, hood, trunk panel, quarter panel, and the like.

The method may comprise one or more optional steps directed to preparing the repair area for subsequent application of the coating compositions according to the methods described herein. These steps may include washing the repair area with one or more solvents and/or cleaning agents; sanding the repair area to remove surface imperfections; and repairing or replacing missing portions of the substrate or surface imperfections (dents, for example). This latter step may involve using suitable, conventional body fillers to fill holes, dents, or other imperfections in the substrate.

If priming is required, the method comprises the step of applying to the repair area an ambient temperature curing, solvent-borne primer coat composition. For purposes of clarity, “ambient temperatures” refers to temperatures of between about 55° F. and about 115° F. More usefully, the primer coat composition will cure at ambient temperatures (dry to sand) in less than about 20 minutes, and more usefully, less than about 15 minutes.

A particularly useful primer coat composition may comprise a solvent-borne blend of components comprising: (i) at least one polyol resin; (ii) at least one blocked amine; (iii) at least one polyisocyanate; (iv) a metal catalyst, such as a tin compound, for accelerating the isocyanate/hydroxyl reaction; and (v) a volatile organic acid.

Polyol resins useful in the primer coat composition may include monomeric compounds and polymeric compositions having two or more hydroxyl groups per molecule, notwithstanding the optional presence of other functional groups such as carboxyl, amino, urea, carbamate, amide and epoxy groups. The primer composition may comprise a single polyol resin or a blend of polyol resins, which may include blends of polymeric polyols, monomeric polyols or both.

Suitable monomeric polyols may include diols such as ethylene glycol, dipropylene glycol, 2,2,4-trimethyl 1,3-pentanediol, neopentyl glycol, 1,2-propanediol, 1,4-butanediol, 1,3-butanediol, 2,3-butanediol, 1,5-pentanediol, 1,6-hexanediol, 2,2-dimethyl-1,3-propanediol, 1,4-cyclohexanedimethanol, 1,2-cyclohexanedimethanol, 1,3-cyclohexanedimethanol, 1,4-bis(2-hydroxyethoxy)cyclohexane, trimethylene glycol, tetramethylene glycol, pentamethylene glycol, hexamethylene glycol, decamethylene glycol, diethylene glycol, triethylene glycol, tetraethylene glycol, norbornylene glycol, 1,4-benzenedimethanol, 1,4-benzenediethanol, 2,4-dimethyl-2-ethylenehexane-1,3-diol, 2-butene-1,4-diol, and higher level polyols such as trimethylolethane, trimethylolpropane, trimethylolhexane, triethylolpropane, 1,2,4-butanetriol, glycerol, pentaerythritol, dipentaerythritol, and the like.

Exemplary polymeric polyols may include polyether polyols, polyester polyols, acrylic polyols, polycaprolactone polyols, polyurethane polyols, and polycarbonate polyols. Acrylic polyols are particularly desirable.

Polyether polyols may be prepared as the reaction products of ethylene or propylene oxide or tetrahydrofuran with diols or polyols. Polyethers derived from natural products such as cellulose and synthetic epoxy resins may also be used in this invention. Polyester polyols may be prepared by the reaction of dials, triols or other polyols with di-or polybasic acids. Alkyds with hydroxy functional groups may be prepared in a similar process except that mono functional fatty acids may be included. Acrylic polyols may be prepared as the polymerization products of an ester of acrylic or methacrylic acid with hydroxy containing monomers such as hydroxyethyl, hydroxypropyl or hydroxybutyl ester of acrylic or methacrylic acid. Acrylic polymers can also contain other vinyl monomers such as styrene, acrylonitrile vinyl chloride and others. Polyurethane polyols may be prepared as the reaction products of polyether or polyester polyols with diisocyanates.

Numerous blocked amines well known in the art may be used in the present invention. Blocked amines are herein defined as those amines that will produce primary and secondary amines when exposed to water or water vapor, with or without the release of the respective aldehyde or ketone. Deblocking of the blocked amine may be accelerated by the organic acid (discussed below). Preferred blocked amines include aldimines, ketimines and oxazolidines. Aldimines are commercially produced by the condensation of aldehydes with primary diamines, followed by removal of the water by-product. Ketimines are produced in a similar fashion, with ketones being utilized in place of the aldehydes. Oxazolidines are produced by condensing either ketones or aldehydes with alkanolamines, with the water by-product again being removed.

The primer composition may include any isocyanate functional molecule conventionally used making polyurethanes or polyureas. Typical isocyanate functional molecules useful in the compositions of this invention will have an average of at least two isocyanates per molecule, and more usefully three isocyanates per molecule. Representative polyisocyanates useful in the present invention include the aliphatic compounds such as ethylene, trimethylene, tetramethylene, pentamethylene, hexamethylene, 1,2-propylene, 1,2-butylene, 2,3-butylene, 1,3-butylene, ethylidene and butylidene diisocyanates; the cycloalkylene compounds such as 3-isocyanatomethyl-3,5,5-trimethylcyclohexylisocyanate, and the 1,3-cyclopentane, 1,3-cyclohexane, and 1,2-cyclohexane diisocyanates; the aromatic compounds such as m-phenylene, p-phenylene, 4,4-diphenyl, 1,5-naphthalene and 1,4-naphthalene diisocyanates; the aliphatic-aromatic compounds such as 4,4-diphenylene methane, 2,4- or 2,6-toluene or mixtures thereof, 4,4′-toluidine, and 1,4-xylylene diisocyanates; the nuclear substituted aromatic compounds such as dianisdine diisocyanate, 4,4′-diphenylether diisocyanate and chlorodiphenylene diisocyanate; the triisocyanates such as triphenyl methane-4,4′,4″-triisocyanate, 1,3,5-triisocyanatebenzene and 2,4,6-triisocyanate toluene; and the tetraisocyanates such as 4,4′-diphenyl-dimethyl methane-2,2′,5,5′-tetraisocyanate; the polymerized polyisocyanates such as dimers and trimers, and other various polyisocyanates containing biuret, urethane, and/or allophanate linkages.

Preferred polyisocyanates include dimers and trimers of hexamethylene diisocyanate, isophorone diisocyanate, and mixtures thereof.

The primer composition further includes a suitable catalyst used for the reaction of active hydrogen containing compounds and isocyanates. Suitable catalysts for this reaction include, for example, tertiary amines, and metal catalysts. Typical metal catalysts may include tin, zinc, copper and bismuth materials such as dibutyl tin dilaurate, stannous octanoate, dibutyl tin diacetate, dibutyl tin dilaurate, dibutyl tin oxide, tetrabutyl-1,3-diacetoxydistannoxane, zinc octoate, copper naphthenate, bismuth octoate and the like.

The primer composition may further include a volatile organic acid, which may be a carboxylic acid. Particularly useful organic acids include volatile carboxylic acids, including, for example, formic acid, acetic acid, propionic aid, butyric acid, isobutyric acid, valeric acid, isovaleric acid, hexanoic acid, heptanoic acid, and octanoic acid, etc, and blends thereof. Acetic and propionic acid are particularly useful, with acetic acid being desirable for its volatility. As indicated above, these acids are particularly useful for accelerating deblocking of the amine.

The primer composition may include one or more inert organic solvents, such as aliphatic and aromatic hydrocarbon solvents, exemplified by toluene, xylene, ethyl benzene, aromatic naphtha, mineral spirits, hexane, aliphatic naphtha, and the like, and oxygenated solvents, such as ketone solvents, ester solvents, ether solvents, alcohols and the like, including butyl acetate, ethylene glycol monoethyl ether acetate, ethylene glycol monobutyl ether acetate, methyl amyl ketone and methyl isobutyl ketone, methanol, ethanol, propoanol, and the like.

One particularly useful primer coat composition may be obtained by blending P30 series SpectraPrime™ primer, available from The Sherwin-Williams Company, with SR15—SpectraPrime Speed Reducer, available from The Sherwin-Williams Company, with UH80 ULTRA System Low VOC Air Dry Hardener, available from The Sherwin-Williams Company. In another embodiment of the primer coat composition, the reducer may comprise about 0.5% by weight of a metal catalyst, about 24.1% by weight of at least one aliphatic polyamine, and about 75.4% by weight of at least one inert solvent. The primer, reducer and hardener may be blended in a ratio of about 2:2:1.

The primer coat composition may be applied by any conventional means; however, spray application is a particularly useful application means. One or more primer coats may be applied. Where multiple primer coats are applied, it may be useful according to the methods of the present invention to provide a flash time for each intermediate layer, at ambient temperatures, of less than about 5 minutes, in other embodiments, less than 2 minutes, in still further embodiments, less than about 1 minute, in still further embodiments, less than about 45 seconds, and in still further embodiments, about 30 seconds. Flash times of between about 30 seconds and 5 minutes are useful, or alternatively, between about 30 seconds and about 2 minutes. In some embodiments, there may be substantially no flash time associated with the primer coats. The flash time may be no longer than that minimal time between the first application pass and the second application pass in a conventional wet on wet application process.

The primer coat compositions described herein will preferably cure to allow sanding of the primer coat layer within about 20 minutes at ambient temperatures and, preferably about 15 minutes at ambient temperatures. Application of thermal radiation, such as infrared radiation, to the primer coat layer may be employed as a curing process, but is not required. However, where thermal radiation is applied as a curing process, the cure time of the primer coat layer may be reduced to about 5 minutes.

Following the optional application of a primer coat layer, one or more layers of a water-borne basecoat composition may be applied to the damaged area. Most usefully, the basecoat layer may be a refinish, water-borne basecoat layer based on urethanes, acrylics, polyesters, polyethers, and the like. The basecoat layer may be tinted with suitable colorants and pigments so that the basecoat layer will match the basecoat color of the surrounding undamaged area. However, in other embodiments, it will be recognized that it may be useful to provide a different basecoat color than the surrounding, undamaged area.

Using a water-borne basecoat composition, instead of a solvent-borne basecoat composition may reduce overall VOC emissions associated with the system; however, the water in a basecoat composition can detrimentally retard film formation, particularly in a rapidly applied multi-layer or multi-coat finishing system. Failure to adequately remove water from the applied basecoat, particularly prior to application of the clear topcoat can result in a cloudy appearance.

Without intending to limit the suitable water-borne basecoat compositions that may be used in accordance with the present invention, water-borne basecoat compositions as described in U.S. Patent Publication No. 20070010612 are particularly useful in the practice of the present invention. Exemplary such basecoat compositions generally comprise one or more toner compositions (described below) and optionally (i) one or more reducers; (ii) a mixing clear; and (iii) crosslinking agents mixed with the toner prior to application.

The toners may be formulated by mixing one or more pigmented dispersions and one or more letdown clear components, the latter comprising a hydroxyl-functional polyurethane dispersion (PUD) as a binder, which may be the reaction product of (A) an isocyanate pre-polymer intermediate and (B) a chain extenders. The toners may further include water, organic solvents, filler pigments, other resins, such as aqueous emulsion polymers produced by a free-radical addition polymerization reaction, such as acrylic latexes, water reducible resins, such as water reducible polyester, and cellulose esters, such as carboxymethylcellulose acetate butyrate, and one or more other additives in varying amounts and combinations, including, for example, defoamers, dispersants, rheology modifiers, passivating agents, biocides, surfactants, neutralizing agents, solvents, flattening agents, solvents, and UV stabilizers as are known in the art.

Describing the PUD in further detail, Component (A), the isocyanate pre-polymer, may be comprised of the reaction product of (i) an isocyanate compound and (ii) an active hydrogen-containing compound. In one embodiment, a molar excess of the isocyanate may be used. Component (B), the chain extenders, may be comprised of compounds having at least two active hydrogens and at least one hydroxyl group. In use, the hydroxyl-functional PUD's of the present invention may be cured by evaporation of water and the coalescence of the individual polymer particles.

Isocyanates may include aliphatic cycloaliphatic, or aromatic isocyanates or mixtures thereof. The isocyanate may comprise, for example, monoisocyantes, diisocyanates or higher polyisocyanates. In addition, the isocyanates may be selected from saturated or unsaturated oligomeric isocyanates, for example those formed by the reaction of compounds such as maelic anhydride/neopentyl glycol oligomer which is reacted with an isocyanate compound. Further, substituted organic isocyanates including substituents where the substituents are, for instance, nitro, chloro, alkoxy and other groups which are not reactive with hydroxyl groups or active hydrogens, provided the substituents are not positioned to render the isocyanate group or groups unreactive.

Examples of active-hydrogen containing compounds include polymeric polyhydroxyl compounds such as polyhydroxylated polyethers, polyesters, polyesteramids, polycarbonates, hydroxyl-functional acrylics, hydrocarbons, hydroxyl functional polybutadienes and hydroxyl functional hydrogenated polybutadienes. Polyester polyols or polyether polyols may be used to form the pre-polymer. Other polyhydroxyl compounds such as ethylene glycol, propylene glycol, diethylene glycol, glycerol, sorbitol, pentaerythritol, dipropylene glycol and the like may also be used, alone or in combination with the polymeric polyhydroxyl compounds.

Useful chain extenders may comprise diamino alcohols, and particularly those containing any combination of primary or secondary amine and hydroxyl groups. Examples of suitable diamino alcohols include, but are not limited to 1,3-diamino-2-propanol and aminoethylethanolamine. Such chain extenders may be selected to provide the polyurethane with pendant hydroxyl groups positioned along the polymer backbone, rather than terminal positions. In one embodiment, the polyurethane is substantially free of terminal hydroxyl groups. In another useful embodiment, the polyurethane comprises at least 2 pendant hydroxyl groups, but is substantially free of terminal hydroxyl groups.

The hydroxyl-functional polyurethane polymers may have a molecular weight that is at least about 5,000 and further that is at least about 10,000. The polyurethane polymer may have an Mn of about 20,000 as measured at room temperature by gel permeation chromatography based on a polystyrene standard.

In one useful embodiment, the hydroxyl-functional PUD may have a solids content of about 33-35%. In another useful embodiment, the dispersion has a maximum viscosity of about 500 cP, measured by a Brookfield viscometer.

Crosslinking or curing agents may be employed in combination with the polyurethane dispersion. Any additional crosslinking or curing agent compounds that are reactive with hydroxyl functionality may be combined with the hydroxyl-functional PUD shortly before application or during application, such as by a 2-component sprayer. Such crosslinking or curing agents include, but are not limited to, isocyanates or melamines.

The hydroxyl-functional PUD may comprise about 10% to about 85% of a letdown clear composition. The hydroxyl-functional PUD may comprise about 7% to about 60% of a toner composition. Toner compositions may comprise about 7% to about 10% by weight of the hydroxyl-functional PUD. In an alternative embodiment, the toner compositions comprise 7% to 10% by weight of the hydroxyl-functional PUD and a combination of acrylic emulsion polymers, water-reducible polyester resins, and cellulose esters make up the remainder of the resin matrix. A toner composition may comprise about 15% to about 40% by weight of the hydroxyl-functional PUD described herein. In still another exemplary embodiment, a toner composition comprises about 30% to about 60% by weight of the hydroxyl-functional PUD.

The toner or basecoat formulation may include pigments, which may be chromatic or effect pigments. Chromatic pigments comprise various organic and inorganic pigments including but not limited to titanium dioxide; carbon black; graphite black; transparent and opaque iron oxide reds and yellows, nickel titanate yellows; bismuth vanadate yellows; quinacridone reds, magentas and purples; phthalocyanine copper blues and greens; naphthlenolato copper yellow; isoindolinone yellow; benzimidazolone yellows and oranges; diketo pyrrolo pyrolle oranges and reds; anthraquinone red; oxazine violet; and indanthrone blue. Effect pigments include metallic pigments, such as aluminum pigments, including coated aluminum pigments such as iron oxide coated aluminum, and opalescent pigments, such as micas and aluminum oxide platelets coated with various metal oxides.

In general, letdown clear components may comprise about 10% to about 85% by weight of the hydroxyl-functional PUD. The letdown clear may also comprise water, organic solvents, gloss reducing agents, rheology modifiers, defoamers, surfactants, pH neutralizing agents, biocides, or other resins in varying amounts. If included, water may comprise up to about 50% by weight of the letdown clear. Also, if included, organic solvents may comprise up to about 15% by weight of the letdown clear. In addition, ingredients such as amorphous silica and organoclay may be included to enhance various properties of the basecoat composition. If included, amorphous silica may comprise up to about 2% by weight of the letdown clear. If included in the letdown clear, organoclay may comprise up to about 1% of the total weight. Other commercially available additives may be included in trace amounts or in amounts sufficient to achieve desired properties or in accordance with the manufacturer's instructions. In addition, other resins as described above may be incorporated into a letdown clear as described herein below.

In general, useful pigment dispersions for use in the basecoat composition n comprise one or more resins, solvents (e.g. water or organic solvents), pigments and other additives usually selected from those described above. The pigment dispersions may comprise up to about 80% by weight pigment.

In one useful embodiment, a pigment dispersion comprises pigment, a co-grind resin, water, and optionally, pH neutralization agent, dispersing aid(s), and defoamer(s). In one embodiment, a hydroxyl-functional resin useful as a co-grind resin may be prepared by free-radical addition polymerization in 2-butoxy ethanol using t-butyl peroctoate as initiator between about 5% to about 15% methyl methacrylate, about 5% to about 15% styrene, about 10% to about 20% butyl acrylate, about 35% to about 45% butyl methacrvlate, about 10% to about 20% hydroxy ethyl methacrylate and about 5% to about 10% acrylic acid, all monomer percentages by weight of total monomer added. Cogrind resins formulated as above may be slightly acidic, therefore, the resin may be neutralized in water to form a solution before adding any other components. A pH neutralization agent, such as an amine, may be included in the pigment grind composition to provide about 100% to about 130% neutralization of the co-grind resin. Such levels of neutralization may make the dispersed co-grind resin slightly basic.

In another embodiment, a pigment dispersion may comprise one or more resins, one or more solvents, pigment, one or more passivating agents, one or more dispersing aids, and one or more pH neutralizing agents. In one useful embodiment, a pigment may comprise about 10% to about 50%, e.g. about 20% to about 40%, by weight of the pigment dispersion. Also, the one or more resins may be selected from a co-grind resin, a water-reducible resin, an aqueous emulsion polymer, and a cellulose acetate butyrate (“CAB”) type resin, or combinations thereof. As a further example, the resin may comprise a water-reducible polyester resin.

In one embodiment, a toner composition comprises (a) a pigment dispersion, (b) a letdown clear, optionally (c) water, and optionally (d) rheology modifier. For example, a pigment dispersion may comprise about 6% to about 70% of the total toner weight while the letdown clear may comprise about 30% to about 94% of the total toner weight. The ratio of the pigment dispersion to the letdown clear may depend on the type of pigment. In general, the pigment dispersion to letdown clear ratio is highest for toners with inorganic yellow and white pigments which have a greater density and have relatively poor coverage properties. The ratio lessens for toners that contain transparent blue, green and red organic pigments. Additional water and rheology modifiers depend on the desired characteristics of the toner and basecoat.

In another embodiment, the toner formulation does not follow the general procedure of mixing a pigment dispersion with a letdown clear. For some pigments, a pigment dispersion or a pigment and other additives as described herein may be added to a letdown clear containing the hydroxyl-functional PUD and mixed until a desired viscosity is achieved to form a toner. Such a toner may then be mixed with a mixing clear composition prior to application. The mixing clear may comprise a hydroxyl-functional PUD, co-grind resin, and one or more other resins such as aqueous emulsion polymers, water-reducible resins, and cellulose esters (e.g. CMCAB) as described herein. The mnixing clear may also comprise water, defoamers, pH neutralizing agents, biocides, solvents, and surfactants.

Also useful for pursposes of the present invention are those water-borne basecoat compositions sold as AWX® basecoat compositions from The Sherwin-Williams Company.

As with the primer coat composition, layers of basecoat composition may be applied by any conventional means; however, spray application is particularly useful.

According to the methods of the present invention, at least a first basecoat layer may be applied to the repair area. When using a water-borne basecoat composition, it is particularly useful to pre-heat the substrate in and around the repair area with radiant heat, prior to applying the water-borne basecoat layer. Radiant heat is preferred over convection heat in the present invention. Radiant heat may be applied by using an infrared light. The substrate may be heated with an infrared light to a temperature that is higher than the Tg of the basecoat resin. In other embodiments, the substrate may be heated to temperatures of about 70 to 120° F. Following application of the water-borne basecoat composition to the heated substrate, the basecoat layer may be force flashed with a venturi dryer or other source or ambient air flow directed to the basecoat layer for a flash time. A useful flash time may be less than about 5 minutes, though in other embodiments, less than about 2 minutes, and in still further embodiments, about 90 seconds. Flash times of between about 1 minute and about 5 minutes are particularly useful. The venturi dryer may be an air dryer gun. The air flow supplied by the air source may be between about 5 to about 20 cfm.

Following the flash time, subsequent basecoat layers may be applied until hiding is achieved. A pre-heating step, using a radiant heat source, as described above, should be performed prior to applying each layer of water-borne basecoat composition. Usefully, each applied layer will be flashed using the venturi dryer for a flash time, which may be up to about 5 minutes, preferably from about 1 minute to about 2 minutes. Longer flash times with the venturi dryer may be undertaken, but under the embodiments contemplated herein, a flash time of between about 1 minute and about 2 minutes is desirable.

In some embodiments, it may be useful to apply as the final basecoat layer a droplet coat to help with orientation of metallic pigments, if present in the basecoat composition. This final basecoat layer may be force flashed with the venturi dryer as provided above.

Following application of the final basecoat layer and flash time with the venturi dryer, one or more layers of a clearcoat composition may be applied to the basecoat layer. Clearcoat compositions useful for the present invention may include those described in U.S. patent application Ser. No. 11/753,171 and U.S. Pat. No 7,279,525.

In one embodiment, the clearcoat composition may comprise the solvent borne mixture of (i) at least one hydroxy functional acrylic polymer; (ii) optionally, at least one low molecular weight polyol diluent; (iii) at least one polyisocyanate; (iv) a metal catalyst such as a tin compound; and (v) a carboxylic acid.

In another embodiment, the clearcoat composition may comprise (on a weight solids basis of the vehicle solids): (i) about 20 to about 70% of a hydroxy functional acrylic polymer having a number average molecular weight less than about 3,000, for example less than about 2,400; (ii) optionally, about 2- to about 30% of a low molecular weight polyol reactive diluent; (iii) about 10- to about 55% of a polyisocyanate; (iv)at least about 0.2%, for example at least about 0.2% to about 2.92% of a tin catalyst compound such as dibutyltin dilaurate; and (vi) at least about 2.0%, for example, at least about 3% to about 20% of a carboxylic acid, such as propionic acid.

The hydroxy-functional acrylic polymers, which can be conveniently prepared by free radical polymerization techniques as is well known in the art, may have an average of at least two active hydrogen groups per molecule and a number average molecular weight less than about 3,000, or less than about 2,400 measured by gel permeation chromatography relative to a polystyrene standard.

The optional, low molecular weight polyol diluent may have number average molecular weights less than about 1,000 or less than about 500 as measured by gel permeation chromatography relative to a polystyrene standard, and may include polyether polyols, polycaprolactone polyols and saturated and unsaturated polyols. Representative polyol diluents include diols such as ethylene glycol, dipropylene glycol, 2,2,4-trimethyl 1,3-pentanediol, neopentyl glycol, 1,2-propanediol, 1,4-butanediol, 1,3-butanediol, 2,3-butanediol, 1,5-pentanediol, 1,6-hexanediol, 2,2-dimethyl-1,3-propanediol, 1,4-cyclohexanedimethanol, 1,2-cyclohexanedi-methanol, 1,3-cyclohexanedimethanol, 1,4-bis(2-hydroxyethoxy)cyclohexane, trimethylene glycol, tetramethylene glycol, pentamethylene glycol, hexamethylene glycol, decamethylene glycol, diethylene glycol, triethylene glycol, tetraethylene glycol, norbornylene glycol, 1,4-benzenedimethanol, 1,4-benzenediethanol, 2,4-dimethyl-2-ethylenehexane-1,3-diol, 2-butene-1,4-diol, and polyols such as trimethylolethane, trimethylolpropane, trimethylolhexane, triethylolpropane, 1,2,4-butanetriol, glycerol, pentaerythritol, dipentaerythritol, etc.

Useful polyisocyanates may include those described above and having an average of at least about two isocyanate groups per molecule.

The composition of the clear coat may optionally comprise suitable organosilicon compounds, such as an amino functional silane, which may be added to the curable composition and in some embodiments may to enhance the scratch resistance of coatings formed from the composition.

Useful carboxylic acids may include those having low boiling points, for example, acids that boil at less than about 200° C., for example, less than about 175° C., further for example, less than about 165° C., even further for example, less than about 150° C., and finally for example, less than about 145° C. Propionic acid is particularly useful. However, other acids may be used, including but not limited to acetic acid, formic acid, butyric acid, and valeric acid.

Typical metal catalysts that may be used for the reaction between the polyisocyanate and the active hydrogen-containing material include tin, zinc, copper and bismuth materials such as dibutyl tin dilaurate, stannous octanoate, dibutyl tin diacetate, dibutyl tin dilaurate, dibutyl tin oxide, zinc octoate, copper naphthenate, bismuth octoate and the like.

A particularly useful clearcoat composition according to the references cited above may be formed according to the following formula:

| Component | Weight Percent |
|---|---|
| Acrylic Resin | 38.9 |
| Low molecular weight polyester polyol | 1.0 |
| reactive diluent | |
| N-Butyl Acetate | 15.5 |
| 2-butoxyethyl acetate | 1.6 |
| Ethyl 3-ethoxypropionate | 3.7 |
| Methyl N-Amyl Ketone | 6.0 |
| Methyl N-Propyl Ketone | 2.0 |
| Acetone | 16.0 |
| Light stabilizer | 1.1 |
| Modified silicone solution¹ | 0.2 |
| Acetic acid | 0.7 |
| Dibutyltin dilaurate | 0.1 |
| HDI Trimer² | 13.1 |

¹Byk 310 available from Byk-Chemie.
²Tolonate HDT, available from Rhodia.

As previously described, the clearcoat composition can be applied by any application method known in the art, but preferably will be spray applied. The basecoat and the clearcoat may each be applied to give a dry film thickness of about 0.2 to about 6, and especially about 0.5 to about 3.0 mils.

In a particularly useful embodiment, two layers of clearcoat composition may be applied to the repaired surface wet on wet to a dry film thickness of between about 1.5 and 2.0 mils.

Following application of the clearcoat layers, sanding and buffing of the repaired area may be completed as necessary to improve appearance. As indicated above, the clearcoat layer may be dry to sand and buff in about 15 minutes at ambient temperatures. Additionally, the clearcoat may be sufficiently dry to prevent ambient dust from sticking to the coating, in less than about 10 minutes. As with the primer coat layer, thermal radiation curing process may be employed in conjunction with the clearcoat layer to significantly reduce the cure time to sand and buff. Using heat may, in some embodiments, facilitate curing the clearcoat to allow sanding and buffing in about 5 minutes or less.

The selection of materials described herein to form a basecoat/clearcoat system, and, in another embodiment, a primer coat/basecoat/clearcoat system, in connection with use of the venturi dryer to flash the basecoat layers and a heating step prior to each application of basecoat composition, facilitate a process for spot repairing a vehicle that can be completed (dry to buff) with less than about 45 minutes, and preferably less than about 35 minutes, of total cure time for the basecoat/clearcoat system and less than about 65 minutes, and preferably less than about 55 minutes, of total cure time (dry to buff) for the primer coat/basecoat/clearcoat system. By using heat (thermal radiation) in the cure process of the primer coat and clearcoat, in place of or in addition to a force drying process using ambient air, the total cure time may be reduced to about 15 to 30 minutes in the basecoat/clearcoat system and about 30 to 40 minutes in the primer coat/basecoat/clearcoat system of the present invention.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

We claim:

1. A method of coating a substrate, the method comprising the steps of:
(a) providing a substrate;
(b) applying radiant heat to the substrate;
(c) applying at least a first layer of a water-borne basecoat composition to the substrate;
(d) force flashing the basecoat composition with ambient temperature air; and
(e) applying at least a first layer of an ambient cure clearcoat composition to the layer of basecoat composition.

2. The method of claim 1, wherein the at least a first basecoat layer is force flashed with a flow of ambient temperature air for less than about 5 minutes.

3. The method of claim 1, wherein the at least a first basecoat layer is force flashed with a flow of ambient temperature air for less than about 2 minutes.

4. The method of claim 3, wherein the first basecoat layer is force flashed with a venturi dryer.

5. The method of claim 1, wherein, following the step of force flashing the basecoat composition with ambient temperature air, the method further comprises the steps of:
(i) applying radiant heat to the substrate;
(ii) applying a second layer of a water-borne basecoat composition on top of the first layer of the basecoat composition; and
(iii) force flashing the second basecoat layer with a flow of ambient temperature air.

6. The method of claim 5, wherein the first layer of basecoat composition is force flashed with ambient temperature air for between about 1 to about 5 minutes; and wherein the second layer of basecoat composition is force flashed with ambient temperature air for between about 1 to about 5 minutes.

7. The method of claim 6, wherein the basecoat composition is tinted.

8. The method of claim 7, wherein the substrate is a vehicle panel.

9. The method of claim 6, wherein, the basecoat layers are force flashed with a venturi dryer.

10. The method of claim 1, wherein, at ambient temperatures, the clearcoat composition will substantially cure to allow buffing of the clearcoat within 15 minutes after application.

11. A method of making repairs to a substrate, the method comprising the steps of:
(a) applying at least a first layer of an ambient cure primer composition to a substrate, wherein the primer composition sufficiently cures at ambient temperatures to allow sanding of the primer layer within 20 minutes after application;
(b) applying radiant heat to the substrate;
(c) applying at least a first layer of a water-borne basecoat composition to the primer layer;
(d) force flashing the basecoat composition with a flow of ambient temperature air for between about 1 to about 5 minutes; and
(e) applying at least a first layer of an ambient cure clearcoat composition to the layer of basecoat composition.

12. The method of claim 11, wherein the primer composition is a solvent-borne blend comprising:
(a) at least one polyol resin;
(b) at least one blocked amine;
(c) at least one polyisocyanate;
(d) a metal catalyst that accelerates an isocyanate/hydroxyl reaction; and
(e) a volatile organic acid.

13. The method of claim 11, further comprising the step of force flashing the primer composition with a flow of ambient temperature air for between about 30 seconds and 2 minutes.

14. The method of claim 13, comprising using a venturi dryer to provide the flow of ambient temperature air.

15. The method of claim 11, wherein, at ambient temperatures, the clearcoat layer is cured to allow buffing within 20 minutes after application.

16. A method of spot repairing damage to the color coat of a vehicle panel, comprising the steps of
(a) applying radiant heat to the area of damage;
(b) applying to the area of damage at least one layer of a pigmented, water-borne basecoat composition having a color that substantially matches the color coat of the vehicle panel surrounding the area of damage;
(c) force flashing the layer of pigmented basecoat composition with ambient temperature air for between about 1 to about 5 minutes;
(d) optionally, applying radiant heat to the area of damage after the first layer of basecoat composition has substantially cured;
(e) optionally, applying at least a second layer of the pigmented, water-borne basecoat composition on top of the first layer of pigmented, water-borne basecoat composition;
(f) applying to the basecoat layer at least one layer of a clearcoat composition wherein the clearcoat composition is curable at ambient temperatures to allow buffing in less than about 20 minutes after application; and
(g) buffing the clearcoat layer.

17. The method of claim 16, wherein, prior to buffing the clearcoat layer, the total time allocated to curing the first basecoat layer and the clearcoat layer is less than about 30 minutes at ambient temperatures.

18. The method of claim 16, further comprising the steps of applying at least a first layer of an ambient cure primer composition to the area of damage prior to the step of applying the at least one layer of a pigmented water-borne basecoat composition.

19. The method of claim 18, wherein, prior to buffing the clearcoat layer, the total time allocated to curing the first primer layer, the first basecoat layer and the clearcoat layer is less than about 65 minutes at ambient temperatures.
